(19) United States
(12) Patent Application Publication
(10) Pub. No.: US 2025/0225616 A1
(43) Pub. Date: Jul. 10, 2025

(54) DEVICE AND METHOD FOR RADAR IMAGE SUPER-RESOLUTION

(71) Applicant: Electronics and Telecommunications Research Institute, Daejeon (KR)

(72) Inventors: Sung Woo JO, Daejeon (KR); Mu Geon KIM, Daejeon (KR); Eui Su LEE, Daejeon (KR); Jung Soo KIM, Daejeon (KR); Kyung Hyun PARK, Daejeon (KR); Il Min LEE, Daejeon (KR); Jae Yeong LEE, Daejeon (KR)

(21) Appl. No.: 19/015,478

(22) Filed: Jan. 9, 2025

(30) Foreign Application Priority Data
Jan. 10, 2024 (KR) 10-2024-0004437

(51) Int. Cl. G06T 3/4053; G01S 13/89; G06T 3/4046

(52) U.S. Cl. CPC G06T 3/4053; G01S 13/89; G06T 3/4046

(57) ABSTRACT

Provided are a device and method for radar image super-resolution. The device includes a memory configured to store at least one instruction and a processor configured to execute the at least one instruction stored in the memory. The processor generates a low-resolution radar image of a target, generates a high-resolution radar image of the target, trains a super-resolution model for performing super-resolution on radar images on the basis of the low-resolution radar image and the high-resolution radar image, and performs super-resolution on a target radar image using the trained super-resolution model.

### CROSS-REFERENCE TO RELATED APPLICATION

This application claims priority to and the benefit of Korean Patent Application No. 10-2024-0004437, filed on Jan. 10, 2024, the disclosure of which is incorporated herein by reference in its entirety.

### BACKGROUND

### 1. Field of the Invention

The present invention relates to a device and method for radar image super-resolution, and more particularly, to a device and method for radar image super-resolution which convert a low-resolution radar image into a high-resolution radar image.

### 2. Discussion of Related Art

There is growing demand for a security system for detecting a variety of substances, including non-metallic materials, in real time without doing any harm to humans. Security systems employing millimeter-waves or terahertz waves are well suited to these requirements because millimeter waves or terahertz waves can penetrate various materials that visible light cannot do, and unlike x-rays or the like, millimeter waves or terahertz waves are non-ionized electromagnetic waves which are harmless to human bodies.

Meanwhile, transmitters and receivers are generally spaced at λ/4 to 1λ apart to measure an image using radar. Since the spatial resolution of a reconstructed image is proportional to the wavelength used for the measurement, it is necessary to utilize a high frequency with a short wavelength to obtain a high-resolution image. However, a high frequency with a short wavelength requires more transmitters and receivers to measure the same area, increasing the overall cost and complexity of the system.

### SUMMARY OF THE INVENTION

The present invention is directed to providing a device and method for radar image super-resolution which is capable of training a super-resolution model using a radio frequency (RF) simulation and deep learning technology and converting a low-resolution radar image into a high-resolution radar image using the trained super-resolution model.

According to an aspect of the present invention, there is provided a device for radar image super-resolution including a memory configured to store at least one instruction and a processor configured to execute the at least one instruction stored in the memory. The processor generates a low-resolution radar image of a target, generates a high-resolution radar image of the target, trains a super-resolution model for performing super-resolution on radar images on the basis of the low-resolution radar image and the high-resolution radar image, and performs super-resolution on a target radar image using the super-resolution model.

The processor may generate the low-resolution radar image by imaging low-resolution radar data generated through a first RF simulation.

The first RF simulation may include operations of generating a target model corresponding to the target and a radar model corresponding to a radar apparatus, when a radar signal with a first frequency is transmitted through the radar model, predicting the radar signal that is reflected by the target model and received by the radar model, and generating the low-resolution radar data on the basis of the predicted radar signal.

The processor may generate the high-resolution radar image by imaging high-resolution radar data generated through a second RF simulation.

The second RF simulation may include operations of generating a target model corresponding to the target and a radar model corresponding to the radar apparatus, when a radar signal with a second frequency, which is higher than the first frequency, is transmitted through the radar model, predicting the radar signal that is reflected by the target model and received by the radar model, and generating the high-resolution radar data on the basis of the predicted radar signal.

The processor may train the super-resolution model using at least one of a generative adversarial network (GAN), a transformer, a convolutional neural network (CNN), and an autoencoder.

When the super-resolution model is trained using the GAN, the processor may generate a fake high-resolution radar image by inputting the low-resolution radar image to a generator of the GAN, calculate a discriminator loss and a generator loss by inputting the fake high-resolution radar image and the high-resolution radar image to a discriminator of the GAN, and update the generator and the discriminator to minimize the discriminator loss and the generator loss.

When the super-resolution model is trained using the transformer, the processor may extract a feature from the low-resolution radar image through the transformer, generate a fake high-resolution radar image on the basis of the feature, compare the fake high-resolution radar image with the high-resolution radar image, and update the transformer on the basis of a comparison result.

According to another aspect of the present invention, there is provided a method for radar image super-resolution including generating a low-resolution radar image of a target, generating a high-resolution radar image of the target, training a super-resolution model for performing super-resolution on radar images on the basis of the low-resolution radar image and the high-resolution radar image, and performing super-resolution on a target radar image using the super-resolution model.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram of a device for radar image super-resolution according to an exemplary embodiment of the present invention;

FIG. 2 is a conceptual diagram of a device for radar image super-resolution according to an exemplary embodiment of the present invention;

FIGS. 3A and 3B are a set of example diagrams of a low-resolution image and a high-resolution image generated by a device for radar image super-resolution according to an exemplary embodiment of the present invention;

FIGS. 4, 5, 6 and 7 are example diagrams illustrating a process in which a device for radar image super-resolution according to an exemplary embodiment of the present invention trains a super-resolution model;

FIGS. 8 and 9 are flowcharts illustrating a method for radar image super-resolution according to an exemplary embodiment of the present invention; and

FIGS. 10A, 10B, 10C, 11A, 11B and 11C are example diagrams showing super-resolution results of low-resolution images acquired from a device for radar image super-resolution according to an exemplary embodiment of the present invention.

### DETAILED DESCRIPTION OF EXEMPLARY EMBODIMENTS

Hereinafter, a device and method for radar image super-resolution according to the present invention will be described with reference to the accompanying drawings. In this process, the thicknesses of lines, the sizes of components, and the like shown in the drawings may be exaggerated for the purpose of clarity and convenience of description. Also, terms used herein are defined in consideration of functions in the present invention, and the terms may vary depending on the intention of a user or operator or precedents. Therefore, these terms are to be defined on the basis of the overall content of the specification.

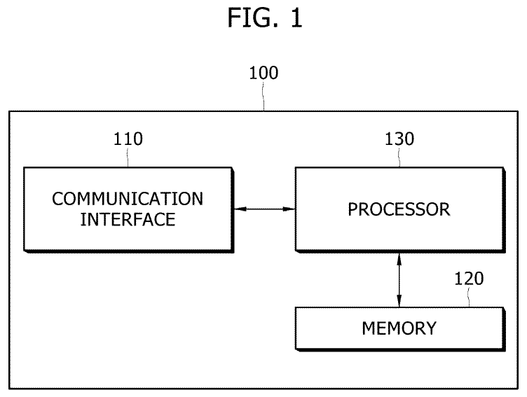

FIG. 1 is a block diagram of a device for radar image super-resolution according to an exemplary embodiment of the present invention.

Referring to FIG. 1, a device 100 for radar image super-resolution according to an exemplary embodiment of the present invention may include a communication interface 110, a memory 120, and a processor 130. The device 100 for radar image super-resolution according to an exemplary embodiment of the present invention may further include various components in addition to the components shown in FIG. 1, or some of the foregoing components may be omitted.

The communication interface 110 may communicate with an external device. The communication interface 110 may communicate with the external device in accordance with various kinds of communication methods.

The memory 120 may store various kinds of information required for operating processes of the processor 130. The memory 120 may store various kinds of information calculated in the operating processes of the processor 130.

The memory 120 may store at least one instruction executed by the processor 130. The memory 120 may be implemented as a volatile storage medium and/or non-volatile storage medium. For example, the memory 120 may be implemented as a read-only memory (ROM) and/or a random access memory (RAM).

The processor may be operably connected to the communication interface 110 and the memory 120. The processor 130 may be implemented as a central processing unit (CPU) or a system on chip (SoC) and may run an operating system (OS) or application to control a plurality of hardware components connected to the processor 130 or a plurality of software components and perform various kinds of data processing and computation. The processor 130 may be configured to execute the at least one instruction stored in the memory 120 and store the execution result data in the memory 120.

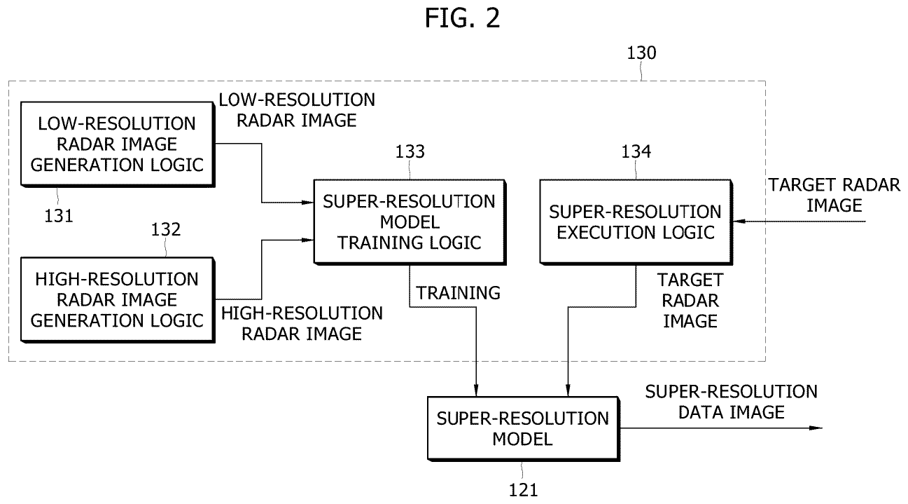

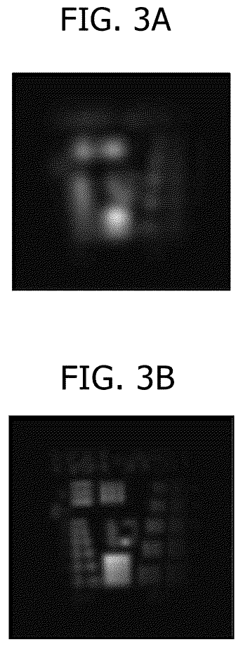

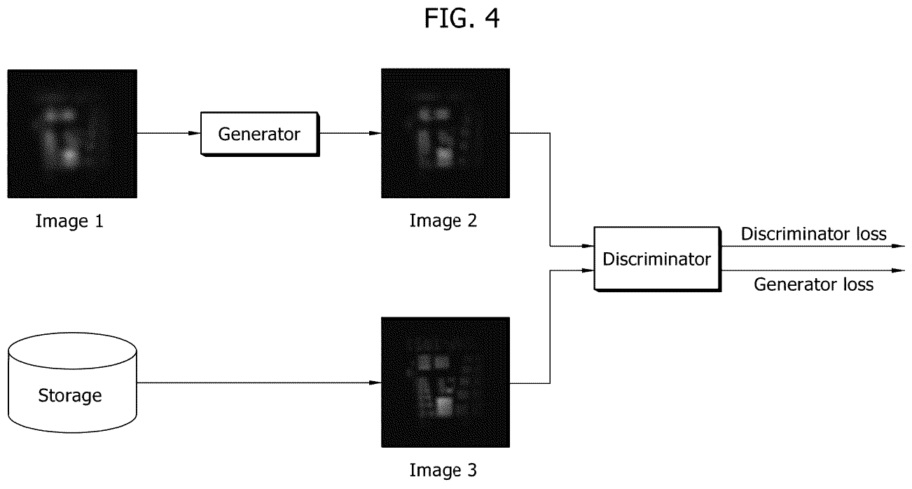

FIG. 2 is a block diagram of a device for radar image super-resolution according to an exemplary embodiment of the present invention, FIGS. 3A and 3B Fare a set of example diagrams of a low-resolution image and a high-resolution image generated by a device for radar image super-resolution according to an exemplary embodiment of the present invention, and FIGS. 4 to 7 are example diagrams illustrating a process in which a device for radar image super-resolution according to an exemplary embodiment of the present invention trains a super-resolution model.

Referring to FIG. 2, the processor 130 of the device for radar image super-resolution according to an exemplary embodiment of the present invention may include a low-resolution radar image generation logic 131, a high-resolution radar image generation logic 132, a super-resolution model training logic 133, and a super-resolution execution logic 134. The logics described in the present embodiment are components that handle some operations of the processor 130 which are classified by function, and an operation performed by each logic may be understood as an operation performed by the processor 130.

The low-resolution radar image generation logic 131 may generate a low-resolution radar image of a target. Here, the target may be an object included in a radar image on which super-resolution will be performed, and the low-resolution radar image may be a radar image under a low-frequency condition. The low-resolution radar image generation logic 131 may generate a low-resolution radar image of a specific target as shown in FIG. 3A.

The low-resolution radar image generation logic 131 may generate a low-resolution radar image of the target by imaging low-resolution radar data generated through a first radio frequency (RF) simulation. The low-resolution radar image generation logic 131 may image the low-resolution radar data using an imaging algorithm which is stored in the memory 120 in advance.

Here, the first RF simulation may include an operation of generating a target model corresponding to the target and a radar model (antenna model) corresponding to a radar apparatus, an operation of, when a radar signal with a first frequency is transmitted through the radar model, predicting the radar signal that is reflected by the target model and received by the radar model, and an operation of generating low-resolution radar data on the basis of the predicted radar signal.

An RF simulation may be a process of, in a virtual space, generating a target model and a radar model, transmitting a radar signal through the radar model, receiving the radar signal reflected by the target model through the radar model, and generating radar data on the basis of the received radar signal.

The memory 120 may store in advance various information (shape information, property information, and the like) required for generating a target model and a radar model, and the low-resolution radar image generation logic 131 may generate a target model and a radar model on the basis of the information stored in the memory 120.

The high-resolution radar image generation logic 132 may generate a high-resolution radar image of the target. Here, the high-resolution radar image may be a radar image under a high-frequency condition. The high-resolution radar image generation logic 132 may generate a radar image that differs from the low-resolution radar image generated by the low-resolution radar image generation logic 131 only in resolution. The high-resolution radar image generation logic 132 may generate a high-resolution radar image of the specific target as shown in FIG. 3B.

The high-resolution radar image generation logic 132 may generate a high-resolution radar image of the target by imaging high-resolution radar data generated through a second RF simulation. The high-resolution radar image generation logic 132 may image the high-resolution radar data using the imaging algorithm which is stored in the memory 120 in advance.

Here, the second RF simulation may include an operation of generating a target model corresponding to the target and a radar model (antenna model) corresponding to a radar apparatus, an operation of, when a radar signal with a second frequency higher than the first frequency is transmitted through the radar model, predicting the radar signal that is reflected by the target model and received by the radar model, and an operation of generating high-resolution radar data on the basis of the predicted radar signal.

The super-resolution model training logic 133 may train a super-resolution model 121 stored in the memory 120 on the basis of the low-resolution radar image generated by the low-resolution radar image generation logic 131 and the high-resolution radar image generated by the high-resolution radar image generation logic 132. Here, the super-resolution model 121 may be a machine learning-based model for converting a low-resolution image into a high-resolution image.

The super-resolution model training logic 133 may train the super-resolution model 121 using, as training data, the low-resolution radar image generated by the low-resolution radar image generation logic 131 and the high-resolution radar image generated by the high-resolution radar image generation logic 132. Here, the super-resolution model training logic 133 may use the high-resolution radar image generated by the high-resolution radar image generation logic 132 as ground truth data.

The super-resolution model training logic 133 may train the super-resolution model 121 using a generative adversarial network (GAN). As shown in FIG. 4, the super-resolution model training logic 133 may generate a fake high-resolution radar image image 2 by inputting a low-resolution radar image image 1 generated by the low-resolution radar image generation logic 131 to a generator of the GAN, calculate a discriminator loss and a generator loss by inputting the generated fake high-resolution radar image image 2 and a high-resolution radar image image 3 generated by the high-resolution radar image generation logic 132 to a discriminator of the GAN, and update the generator and the discriminator to minimize the calculated discriminator loss and generator loss, thereby training the super-resolution model 121.

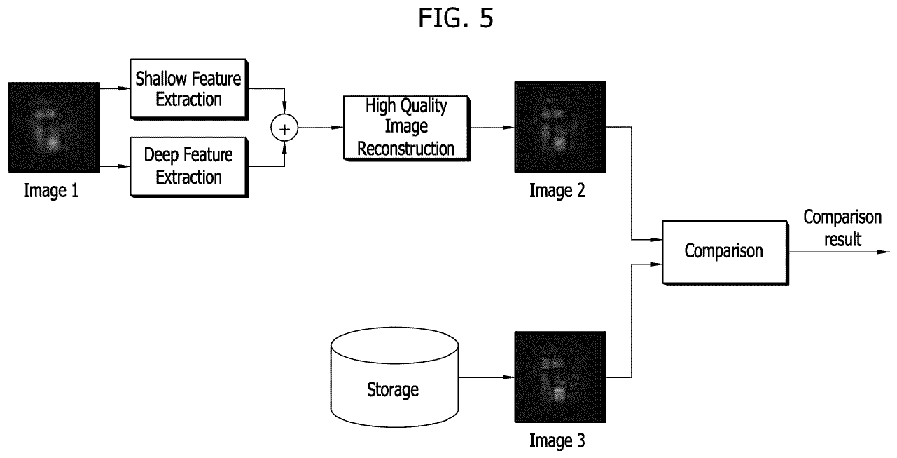

The super-resolution model training logic 133 may train the super-resolution model 121 using a transformer. As shown in FIG. 5, the super-resolution model training logic 133 may extract a shallow feature and a deep feature from the low-resolution radar image image 1 generated by the low-resolution radar image generation logic 131 through the transformer, generate the fake high-resolution radar image image 2 on the basis of the extracted features, compare the generated fake high-resolution radar image with the high-resolution radar image image 3 generated by the high-resolution radar image generation logic 132, and update the transformer on the basis of the comparison result, thereby training the super-resolution model 121.

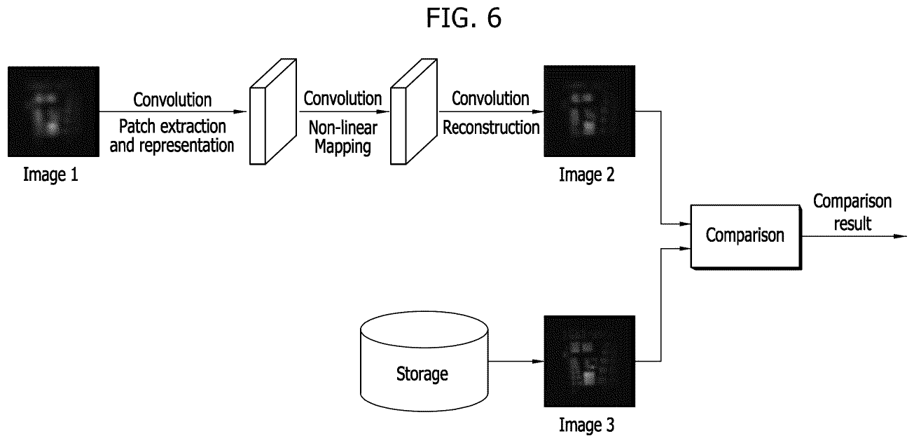

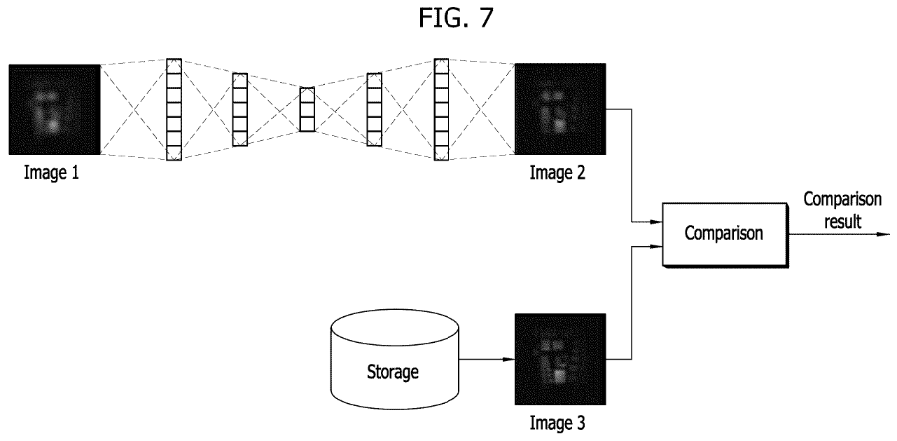

As shown in FIG. 6, the super-resolution model training logic 133 may train the super-resolution model 121 using a convolutional neural network (CNN) model (e.g., a super-resolution CNN (SRCNN) or the like). Also, as shown in FIG. 7, the super-resolution model training logic 133 may train the super-resolution model 121 using an autoencoder. The training method for the super-resolution model 121 is not limited to the above-described exemplary embodiments, and according to the present embodiment, a variety of well-known training methods may be used to train the super-resolution model 121.

The super-resolution execution logic 134 may perform super-resolution on a target radar image using the super-resolution model 121 which is trained by the super-resolution model training logic 133. Here, the target radar image is an actual radar image that is detected by imaging a target through a radar apparatus, and may be a radar image having the same level of resolution as the low-resolution radar image generated by the low-resolution radar image generation logic 131. The super-resolution execution logic 134 may convert the low-resolution target radar image into a high-resolution target radar image using the trained super-resolution model 121.

The super-resolution execution logic 134 may perform super-resolution on the target radar image by inputting the target radar image to the super-resolution model 121. When the target radar image is input, the super-resolution model 121 may output the target radar image on which super-resolution has been performed.

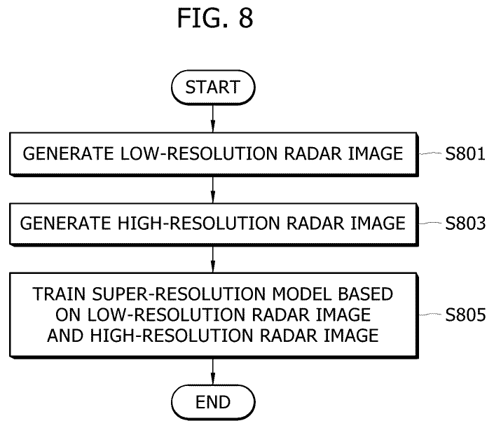

FIG. 8 is a first flowchart illustrating a method for radar image super-resolution according to an exemplary embodiment of the present invention.

A process of training a super-resolution model will be described below with reference to FIG. 8, focusing on operations of the processor 130. A part of the following process may be performed in a different order than that described below or may be omitted.

First, the processor 130 may generate a low-resolution radar image of a target (S801). In operation S801, the processor 130 may generate low-resolution data of the target through a first RF simulation and generate a low-resolution radar image of the target by imaging the generated low-resolution radar data.

Subsequently, the processor 130 may generate a high-resolution radar image of the target (S803). In operation S803, the processor 130 may generate high-resolution data of the target through a second RF simulation and generate a high-resolution radar image of the target by imaging the generated high-resolution radar data.

Subsequently, the processor 130 may train a super-resolution model stored in the memory 120 on the basis of the low-resolution radar image and the high-resolution radar image (S805). In operation S805, the processor 130 may train the super-resolution model using the low-resolution radar image and the high-resolution radar image as training data. In operation S805, the processor 130 may use the high-resolution radar image as ground truth data.

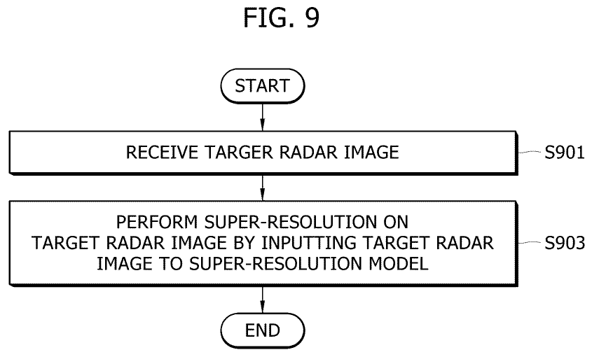

FIG. 9 is a second flowchart illustrating a method for radar image super-resolution according to an exemplary embodiment of the present invention.

A process of performing super-resolution on a target radar image using a super-resolution model will be described below with reference to FIG. 9, focusing on operations of the processor 130. The process of FIG. 9 may be performed after the process of FIG. 8 is completed.

First, the processor 130 may receive a target radar image through the communication interface 110 (S901). In operation S901, the processor 130 may receive an actual radar image on which super-resolution will be performed.

Subsequently, the processor 130 may perform super-resolution on the target radar image by inputting the target radar image to the super-resolution model stored in the memory 120 (S903). In operation S903, the super-resolution model may convert the low-resolution target radar image into a high-resolution target radar image and output the high-resolution target radar image. The converted high-resolution target radar image may be transmitted to an external device through the communication interface 110.

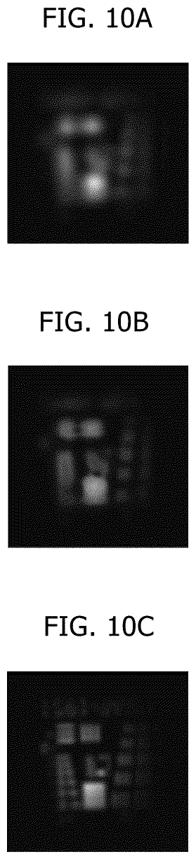

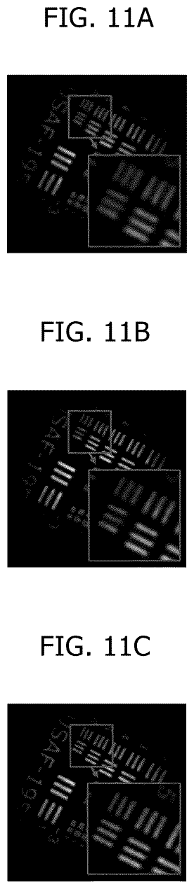

FIGS. 10A to 11C are example diagrams showing super-resolution results of low-resolution images acquired from a device for radar image super-resolution according to an exemplary embodiment of the present invention.

FIG. 10 shows results of performing super-resolution on an actual radar image using a super-resolution model that is trained on the basis of a low-resolution radar image generated through an RF simulation, which is performed using a radar model with a radar signal frequency band of 55 GHz to 75 GHz, and a high-resolution radar image generated through an RF simulation which is performed using a radar model with a radar signal frequency band of 130 GHz to 150 GHz.

FIG. 10A shows an actual radar image that is detected through a radar apparatus with a radar signal frequency band of 55 GHz to 75 GHz, FIG. 10B shows a radar image that is acquired by performing super-resolution on the radar image of FIG. 10A through the super-resolution model, and FIG. 10C shows an actual radar image that is detected through a radar apparatus with a radar signal frequency band of 130 GHz to 150 GHz. As shown in FIG. 10, when super-resolution is performed on a radar image using a super-resolution model according to the present embodiment, it can be seen that the resolution of the radar image is improved.

FIG. 11 shows results of performing super-resolution on an actual radar image using a super-resolution model that is trained on the basis of a low-resolution radar image generated through an RF simulation, which is performed using a radar model with a radar signal frequency band of 130 GHz to 150 GHz, and a high-resolution radar image generated through an RF simulation which is performed using a radar model with a radar signal frequency band of 180 GHz to 200 GHz.

FIG. 11A shows an actual radar image that is detected through a radar apparatus with a radar signal frequency band of 130 GHz to 150 GHz, FIG. 11B shows a radar image that is acquired by performing super-resolution on the radar image of FIG. 11A through the super-resolution model, and FIG. 11C shows an actual radar image that is detected through a radar apparatus with a radar signal frequency band of 180 GHz to 200 GHz. As shown in FIG. 11, when super-resolution is performed on a radar image using a super-resolution model according to the present embodiment, it can be seen that the resolution of the radar image is improved.

A device and method for radar image super-resolution according to the present invention can convert a low-resolution radar image into a high-resolution radar image, and thus it is possible to generate a radar image with a higher spatial resolution than a spatial resolution determined in accordance with the measurement frequency of a radar apparatus.

A device and method for radar image super-resolution according to the present invention train a super-resolution model using a low-resolution radar image and a high-resolution radar image that are generated through RF simulations, thereby reducing the time and cost required for training the super-resolution model.

Although the present invention has been described above with reference to embodiments illustrated in the drawings, the embodiments are merely illustrative, and those of ordinary skill in the art should understand that various modifications and other equivalent embodiments can be made from the embodiments. Therefore, the technical scope of the present invention should be determined from the following claims.

What is claimed is:

1. A device for radar image super-resolution, the device comprising:
a memory configured to store at least one instruction; and
a processor configured to execute the at least one instruction stored in the memory,
wherein the processor generates a low-resolution radar image of a target, generates a high-resolution radar image of the target, trains a super-resolution model for performing super-resolution on radar images on the basis of the low-resolution radar image and the high-resolution radar image, and performs super-resolution on a target radar image using the super-resolution model.

2. The device of claim 1, wherein the processor generates the low-resolution radar image by imaging low-resolution radar data generated through a first radio frequency (RF) simulation.

3. The device of claim 2, wherein the first RF simulation includes operations of:
generating a target model corresponding to the target and a radar model corresponding to a radar apparatus;
when a radar signal with a first frequency is transmitted through the radar model, predicting the radar signal that is reflected by the target model and received by the radar model; and
generating the low-resolution radar data on the basis of the predicted radar signal.

4. The device of claim 3, wherein the processor generates the high-resolution radar image by imaging high-resolution radar data generated through a second RF simulation.

5. The device of claim 4, wherein the second RF simulation includes operations of:
generating a target model corresponding to the target and a radar model corresponding to the radar apparatus;
when a radar signal with a second frequency, which is higher than the first frequency, is transmitted through the radar model, predicting the radar signal that is reflected by the target model and received by the radar model; and
generating the high-resolution radar data on the basis of the predicted radar signal.

6. The device of claim 1, wherein the processor trains the super-resolution model using at least one of a generative adversarial network (GAN), a transformer, a convolutional neural network (CNN), and an autoencoder.

7. The device of claim 6, wherein, when the super-resolution model is trained using the GAN, the processor generates a fake high-resolution radar image by inputting the low-resolution radar image to a generator of the GAN, calculates a discriminator loss and a generator loss by inputting the fake high-resolution radar image and the high-resolution radar image to a discriminator of the GAN, and updates the generator and the discriminator to minimize the discriminator loss and the generator loss.

8. The device of claim 6, wherein, when the super-resolution model is trained using the transformer, the processor extracts a feature from the low-resolution radar image through the transformer, generates a fake high-resolution radar image on the basis of the feature, compares the fake high-resolution radar image with the high-resolution radar image, and updates the transformer on the basis of a comparison result.

9. A method for radar image super-resolution performed by a computing device including a processor, the method comprising:
generating a low-resolution radar image of a target;
generating a high-resolution radar image of the target;
training a super-resolution model for performing super-resolution on radar images on the basis of the low-resolution radar image and the high-resolution radar image; and
performing super-resolution on a target radar image using the super-resolution model.

10. The method of claim 9, wherein the generating of the low-resolution radar image comprises generating the low-resolution radar image by imaging low-resolution radar data generated through a first radio frequency (RF) simulation.

11. The method of claim 10, wherein the first RF simulation includes operations of:
generating a target model corresponding to the target and a radar model corresponding to a radar apparatus;
when a radar signal with a first frequency is transmitted through the radar model, predicting the radar signal that is reflected by the target model and received by the radar model; and
generating the low-resolution radar data on the basis of the predicted radar signal.

12. The method of claim 11, wherein the generating of the high-resolution radar image comprises generating the high-resolution radar image by imaging high-resolution radar data generated through a second RF simulation.

13. The method of claim 12, wherein the second RF simulation includes operations of:
generating a target model corresponding to the target and a radar model corresponding to the radar apparatus;
when a radar signal with a second frequency, which is higher than the first frequency, is transmitted through the radar model, predicting the radar signal that is reflected by the target model and received by the radar model; and
generating the high-resolution radar data on the basis of the predicted radar signal.

14. The method of claim 9, wherein the training of the super-resolution model comprises training, by the processor, the super-resolution model using at least one of a generative adversarial network (GAN), a transformer, a convolutional neural network (CNN), and an autoencoder.

15. The method of claim 14, wherein the training of the super-resolution model comprises, when the super-resolution model is trained using the GAN, generating a fake high-resolution radar image by inputting the low-resolution radar image to a generator of the GAN, calculating a discriminator loss and a generator loss by inputting the fake high-resolution radar image and the high-resolution radar image to a discriminator of the GAN, and updating the generator and the discriminator to minimize the discriminator loss and the generator loss.

16. The method of claim 14, wherein the training of the super-resolution model comprises, when the super-resolution model is trained using the transformer, extracting a feature from the low-resolution radar image through the transformer, generating a fake high-resolution radar image on the basis of the feature, comparing the fake high-resolution radar image with the high-resolution radar image, and updating the transformer on the basis of a comparison result.
